(19) United States
(12) Patent Application Publication
(10) Pub. No.: US 2006/0004540 A1
(43) Pub. Date: Jan. 5, 2006

(54) Method for automated tracking of time and association of the tracked time with accounting categories

(75) Inventors: Rick Allen Hamilton, Charlottesville, VA (US); Jonathan Thomas Harding, Charlotte, NC (US); James Wesley Seaman, Falls Church, VA (US); Harry Schatz, McClean, VA (US)

Correspondence Address: Gregory W. Carr, 670 Founders Square, 900 Jackson Street, Dallas, TX, 75202, US

(73) Assignee: International Business Machines Corporation, Armonk, NY (US)

(21) Appl. No.: 10/881,972

(22) Filed: Jun. 30, 2004

(51) Int. Cl. G06F 15/00

(52) U.S. Cl. 702/176

(57) ABSTRACT

The present invention provides a system for the automated tracking of time spent executing computer applications and processes, the associating of the time with accounting categories, and the reporting of the time spent. The system provides a variety of modes for tracking the time. In an embodiment, the user can specify a stop time for the association of a computer application with an accounting category. In an embodiment, the user can specify information about the billing rates of the time spent executing an application. In an embodiment, the user can associate an application with an accounting category for a period of time.

### TECHNICAL FIELD

The present invention relates generally to time-tracking systems and, more particularly, to a method for the automated tracking of time and the association of the tracked time with accounting categories.

### BACKGROUND

It is often useful to track the time spent performing tasks. Fees are often based, at least in part, on the amount of time spent performing services for clients. For example, professionals such as attorneys and accountants often bill their clients based on the number of hours worked on behalf of the clients. The government often pays contractors based on the number of hours spent by the contractors on the contracts.

Time tracking is important even when not used for billing. A company may be interested in how an employee spends his time even when it does not directly produce fees. The company may be interested in the total time spend by the employee, or in the expenditure of time on particular tasks. The company may reevaluate the utility of the tasks, or discover a need to perform them more efficiently. The time records may even provide a starting point for a more efficient performance of the tasks.

The problem of keeping accurate track of time is exacerbated for consultants and other mobile employees who do a considerable amount of work from a home office and various mobile locations. Frequently, and often during irregular hours, users turn on their computers to perform multiple tasks which may be of a relatively short duration. Some of this computer time can easily be forgotten at the end of an accounting period, when the employee creates a record of time and tasks worked for that accounting period.

Time can be manually entered into a time-keeping system. The manual entry is, however, an unreliable dependency. The user may completely forget to enter the time, or he may delay entering the time until he is unable to remember it accurately. In addition, the user may not have easy access to the proper billing codes, and may not be able to associate the time with the correct accounting categories.

A time keeping system can automatically track the time spent on applications running on a computer. With this system, the user must associate a given task with a time-keeping category each time the task is initiated. The user cannot specify a termination date for the association of a computer activity and an accounting category. In addition, the system is unable to differentiate between different classes of time. Thus, it is unable to indicate different rates for different classes of time. For example, it is unable to note that overtime hours are billed at time and a half. In addition, the system lacks flexibility in its tracking methods. This system gives the user few options for tracking time. In particular, it does not permit the user to track time for applications and assign the time later. It does not permit the user to assign all active time to a particular billing category. It does not permit the user to assign all time to a particular billing category except time spent on certain applications. The system does not permit the user to switch the accounting category to which time is being assigned by putting in the foreground a window associated with a different category. It does not permit the user to review the data recorded by the system and explicitly authorize release of the data. The system does not give the user flexibility in producing a report of the time spent on various activities. The user cannot choose to have the time assigned to a first accounting category displayed in a different format than time assigned to a second accounting category.

Therefore, there is a need for an automated time-tracking system that provides a wide variety of tracking methods, that allows a user to register an application or element of the file system with a category of the accounting system for a limited duration, and that allows the user, by changing the window in the foreground, to switch the accounting category to which the tracked time is being assigned.

### SUMMARY OF THE INVENTION

The present invention provides a system for the automated tracking of time spent executing computer applications and processes, the associating of the time with accounting categories, and the reporting of the time spent. The system provides a variety of modes for tracking the time.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 shows a flow diagram illustrating the automated tracking of time spent on an application and the association of the time with accounting categories;

FIG. 2 illustrates a screen for registering an application;

FIG. 3 illustrates the registration entries for a week; and

FIG. 4 illustrates a report generated by the automated time-tracking system.

### DETAILED DESCRIPTION

In the following discussion, numerous specific details are set forth to provide a thorough understanding of the present invention. However, it will be apparent to those skilled in the art that the present invention may be practiced without such specific details. In other instances, well-known elements have been illustrated in schematic or block diagram form in order not to obscure the present invention in unnecessary detail.

It is further noted that, unless indicated otherwise, all functions described herein may be performed in either hardware or software, or some combination thereof. In a preferred embodiment, however, the functions are performed by a processor such as a computer or an electronic data processor in accordance with code such as computer program code, software, and/or integrated circuits that are coded to perform such functions, unless indicated otherwise.

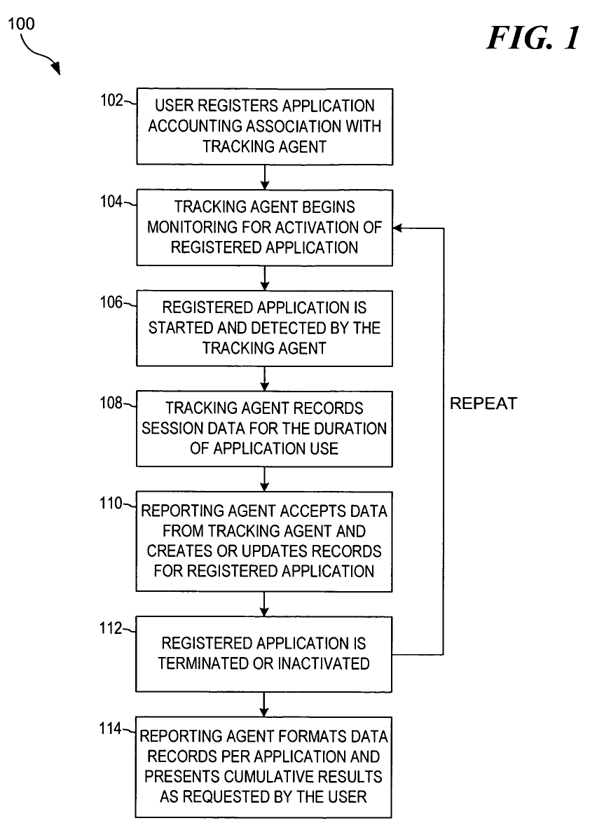

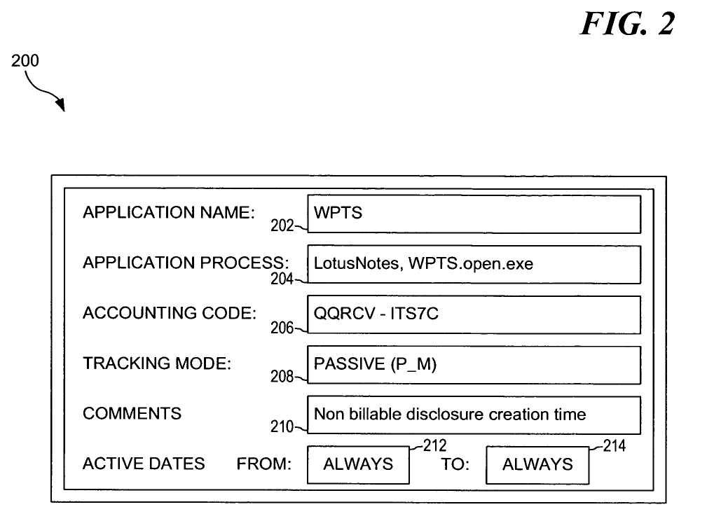

Referring to FIG. 1 of the drawings, the reference numeral 100 generally indicates a flow diagram illustrating the automated tracking of time spent on an application and the association of the time with accounting categories. The diagram 100 illustrates the tracking of a single application. In step 102, the user registers the association of the application and an accounting category with the Tracking Agent. During the registration process, the user also supplies parameters to control the method of monitoring performed by the Tracking Agent. The registration process will be discussed in detail below with FIG. 2.

In step 104, after the registration process is complete, the Tracking Agent begins monitoring for the activation of the registered application. In step 106, the Tracking Agent detects the activation of the registered application. In step 108, the Tracking Agent records data about the use of the registered application. The recording begins each time the registered application is opened or when an element of the file system associated with the application, such as a window or directory, is highlighted; that is, put in the foreground. The recording ends when the application is closed, when recording is begun for another application; or, depending upon the mode of tracking, when there is no activity in the registered application being tracked.

The Tracking Agent monitors session data for the application based on the registration criteria. The data includes the application used and the duration of use of the application. In embodiments of the invention, and depending upon the registration, the data include the start and stop-times of use of the application, and a breakdown of application use by element in a file system, such as a file or directory.

In step 110, the tracking data is passed to the Reporting Agent. The Reporting Agent creates or updates records for the registered application. In an embodiment, the Tracking Agent writes to nonvolatile (NV) storage prior to writing to volatile storage in order to protect against loss of tracking data if power is lost or a system halt occurs. This writing can be at a specified time interval, or based on percent used of the NV storage, or when the user terminates a session, or in accordance with some other method.

In step 112, the registered application is terminated or inactivated and tracking discontinues. The user may close the application, end the session, switch to another application, or cease actively using the application, in some tracking modes.

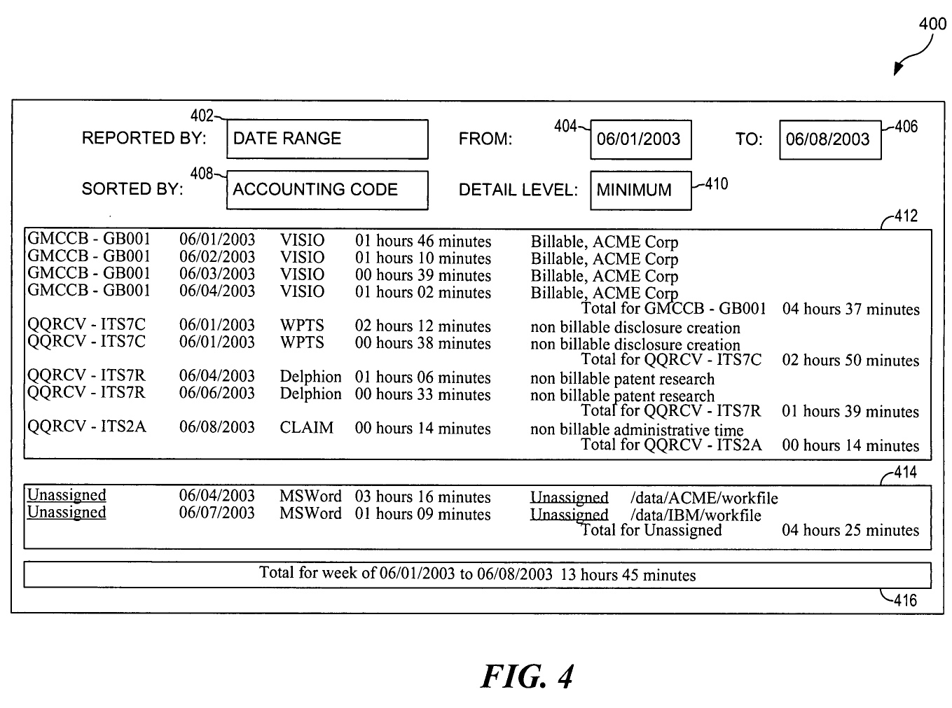

Upon discontinuation of the tracking, the Tracking Agent flushes any pending data to the Reporting Agent and returns to the “monitor for activation” mode of step 104 with respect to the application. In step 114, the Reporting Agent formats the data records as requested by the user. The Reporting Agent can present a report as requested by the user. In an embodiment, the Reporting Agent can pass the data to a corporate capture system, to be used in a central reporting system. The reporting function will be described in greater detail below, in connection with FIG. 4.

FIG. 1 illustrates the tracking of a single application. Multiple applications can also be tracked. The user registers each application. When a registered application becomes active, either by the user launching it or switching to it, a tracking agent keeps track of the time spent on it. As in the single application case, the tracking agent or agents send data to a reporting agent, and the reporting agent formats the data and presents reports. Once an application is terminated or becomes inactive, the tracking agent or agents monitor for the activation of another registered application.

Referring to FIG. 2 of the drawings, the reference number 200 generally indicates an illustrative screen for registering an application. In the example illustrated, the user supplies the application name in box 202 and the accounting code in box 206. The system can furnish the application process, in box 204, from the application name, or can allow the user to supply it himself. The accounting code can be a billing category, such as a particular client, project or supervisor; a category of non-billing work time, such as time-keeping, administrative or continuing education; or a category of non-work time, such as personal e-mail or personal web-browsing.

The user also selects a tracking mode in box 208, to determine the details of the tracking of time for a registered application. In an embodiment of the invention, a large variety of tracking modes are implemented. The following chart details some of the tracking options:

Active Mode (A_M): Track time only while an application is in active use. In an embodiment, an application is treated as having stopped when there is a given delay between uses of the keyboard or movement of the mouse.

Passive Mode (P_M): Track time as long as the application is open, regardless of whether it is actively in use. In passive mode, the time-tracking system continues to track the time for an open application while the user studies a computer screen, looks at a book, or ponders a difficult problem.

Verbose Mode (V_M): Track details of application use such as the name of documents accessed during the session. In this mode, time tracking can be more detailed than at the application level. The embodiment can track the use of individual files or directories or other elements of the file system.

Verbose None (V_N): Track details of application use but do not assign to a specific accounting code. The user can assign or associate the time with accounting categories during the reporting process. This method makes it easy for a user to associate an application generally with a category, but to make exceptions for specific files. With other methods of tracking, the user would have to associate each individual file with a category, even if there are very many files that are associated with one time-keeping category, and a very few with other categories.

Global Complete (G_C): Track computer active time during specified time frame and associate with specified accounting category. This tracking mode obviates the need for a user who uses many applications, all under the same accounting category, to register each application separately under the accounting category.

Global Minus (G_M): Use global tracking for primary contract but subtract active time for specific associated applications.

As illustrated by the Verbose Mode and Verbose None modes, the time-tracking system in embodiments with these modes can monitor at levels lower than the application itself. Individual elements of file systems, such as folders or files, can be registered to accounting codes and tracked. In these embodiments, the user has more granularity in assigning accounting codes to specific entities. In these embodiments, the time-tracking system allows for combined application and file level tracking. A user can choose to track one application at the application level while tracking another application at the file or directory level.

In an embodiment, a pop-up box or other visual mechanism reminds the user of the tracking method in place when tracking is started for an application. These reminder mechanisms are particularly useful for applications such as word processors which may be associated with a number of different accounting categories. These reminder mechanisms can be disabled. In an embodiment, these reminder function are disabled for applications which are always associated in the same manner.

The tracking can be performed by several methods. In one embodiment, a common Tracking Agent would track all application activity. In another embodiment, agents would be segregated by common application type, such as word processors. In yet another embodiment, each individual application would have a unique Tracking Agent or application programming interface (API) to a Tracking Agent.

The registration screen 200 also provides for the entry of user comments in box 210. Finally, registration screen 200 provides for the entry of the active dates for the registration in box 212 and box 214. The user does not have to indicate the accounting category for an application each time he begins a session at a computer and opens an application. By providing an end date, the user can later access a document created by the application without billing the time to the accounting category. For example, the user can look copy an old document for use in a new project without billing the time to an old project.

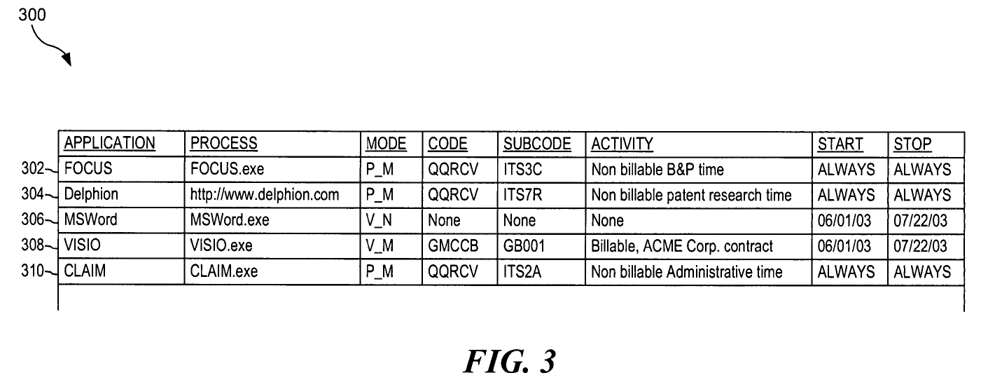

Referring to FIG. 3 of the drawings, the reference numeral 300 generally indicates illustrative registration entries for a week. In the first entry 302 of FIG. 3, the FOCUS application is used to keep track of non-billable B&P time. This application is tracked in passive mode, with the time tracked as long as the application is open, regardless of whether the keyboard or mouse is being used. This application is permanently registered to the accounting code ITS3C. Once the user has made the initial registration, the user does not again have to inform the tracking agent of the registration, or confirm the registration.

In the second entry 304 of FIG. 3, the Delphion website is used for non-billable patent research time. The application process is a website. The website is permanently associated with accounting code ITS7R. The tracking mode is again passive-mode. The user can examine a screen from the website or compare a screen with written material as needed, without the time-tracking system ending the association of the time with the billing category.

In the third entry 306 of FIG. 3, Word is tracked in verbose-none mode. This mode can be used when a user works on one file under an application for one accounting category, and another file under another accounting category. During registration, the user does not associate Word with an accounting code. Instead, the user assigns accounting categories for his time usage of Word after he views the usage. In this tracking mode, the report is broken down by individual files. Alternatively, if a user uses Word almost always for a single accounting category, the user can register Word with that application in verbose-mode and manually reassign some of the time to other accounting categories after viewing the report.

In the fourth entry 308 of FIG. 3, the VISIO application is associated with accounting category GMCCB for a limited time. The association begins on Jun. 1, 2003 and ends on Jul. 22, 2003. Documents accessed after that date will not be billed to this accounting category unless the user takes further action. Thus, if the user wants to review a document for use with another client, the accessing of the document will not be billed to the old user.

In the fifth entry 310 of FIG. 4, the CLAIM application is permanently associated with the accounting category ITS2A, for non-billable administrative time. Again, the mode is passive-mode. Tracking continues even if the user temporarily stops uses the mouse and keyboard.

Referring to FIG. 4 of the drawings, the reference numeral 400 generally indicates an illustrative report generated by the automated time-tracking system. The data gathered by the time-tracking system is used to produce the report. The Tracking Agent sends the data to the Reporting Agent. It can first send the data to NV storage. The Reporting Agent uses the data to create or update records about registered applications. In an embodiment, the Reporting Agent can load data into a relational database or similar software storage facility to allow for data association. Relational databases and indexing allow for virtually any combination of record-to-record association. The user selects reporting options, and the system generates the report.

In an embodiment, the following options are available for reporting:

Time/Date range for report period

Report/Sort by contract number/accounting code

Report/Sort by application

Report/Sort by activity type

Report/Sort by client name

Report/Sort by tracking mode

In an embodiment, an API feeds the data generated by the time-tracking system directly into a corporate labor claiming system. The user reviews and updates the report data, then clicks on a “submit” icon to have the data fed to labor claiming application.

The report in FIG. 4 is based on the example registrations in FIG. 3. The user selected a date range (box 402) for the report from Jun. 1, 2003, (box 404) through Jun. 8, 2003 (box 406). The report is to be sorted by accounting code (box 408), and the detail level is minimum (box 410). Details of the report are given in boxes 412, 414, and 416. The first four lines of the report (box 412) show the daily billing for the accounting code GMCCB, with subcode GB001. The next line is the total billing for that code. The next lines show the daily activity and totals for the accounting code QQRCV, broken down by the subcodes. The last three lines (box 414) describe the usage of Word. Since the tracking mode selected was verbose_none, the report breaks down the usage of Word by document, but does not assign the usage to accounting categories. In an embodiment, the user would then assign the time to accounting categories, and the time-tracking system would perform a real-time update of the record, recalculating totals based on the update information. In an embodiment, the time-tracking system would furnish the user with a pull down menu of all available accounting codes and activities, which the user would key from the “Unassigned field.” The total time for the week is given in box 416.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description of preferred embodiments. Accordingly, it is appropriate that the appended claims be construed broadly and in a manner consistent with the scope of the invention.

1. A method for the automated tracking of time spent on one or more computer applications and the association of the time with accounting categories, comprising the steps of:
registering the one or more applications and the accounting category associations;
monitoring for the use of at least one of the registered computer applications; and
recording the duration of use of at least one of the registered computer applications.

2. The method of claim 1, further comprising the step of storing the recorded data in NV storage.

3. The method of claim 1, wherein registering an application further comprises specifying a stop date for the registration.

4. The method of claim 1, further comprising the step of specifying information about the rates for billing at least one unit of time.

5. The method of claim 4, wherein information about the rates for billing is specified by the inputting of rules.

6. The method of claim 1, wherein the user has a choice among a plurality of modes for tracking the time.

7. The method of claim 6, wherein in one mode of time-tracking, the system keeps track of overall usage of an application and breaks down the usage of the application by elements of the file system, but does not assign the time to accounting categories.

8. The method of claim 7, wherein in another of the plurality of modes of time-tracking, the system tracks time by elements of the file system and assigns the time to accounting categories.

9. The method of claim 6, wherein in one of the plurality of modes of time-tracking, the system tracks time only while an application is in active use; and in another of the plurality of modes of time-tracking, the system tracks time as long as an application is in use, regardless of whether it is actively in use.

10. The method of claim 6, wherein in one mode of time tracking, the system associates all active time during a time frame specified at registration with a specific accounting code.

11. The method of claim 6, wherein in one mode of time-tracking, the system associates all active time during a time frame specified at registration with a specific accounting code, except for active time spent on specified applications.

12. The method of claim 6, wherein the user can choose to track the time spent on a first application by a first tracking mode and to track the time spent on a second, different application by a second, different tracking mode.

13. The method of claim 12, wherein the fields of information reported by the first tracking mode differ from the fields of information reported by the second, different tracking mode.

14. The method of claim 1, wherein the time is tracked for an application when a window associated with the application is in the foreground.

15. The method of claim 1, further comprising the steps of:
reviewing the data recorded by the system; and
explicitly authorizing release of the data.

16. A system for the automated tracking of time spent on one or more computer applications and the association of the time with accounting categories, comprising:
a tracking agent, configured for monitoring the use of applications on a computer, recording the time spent on the applications, and associating the time spent on applications with accounting categories; and
a reporting agent, configured to receive from the tracking agent the data recorded by the tracking agent, and configured for generating reports containing the data.

17. The system of claim 16, configured so that the user has a choice among a plurality of modes for the tracking of time by the tracking agent.

18. The system of claim 17, configured so that in one mode of time-tracking, the tracking agent keeps track of overall usage of an application and breaks down the usage of the application by elements of the file system, but does not assign the time to accounting categories.

19. The system of claim 17, configured so that in one mode of time tracking, the system associates all active time during a time frame specified at registration with a specific accounting code.

20. The system of claim 17, configured so that the user can choose to have the fields of information reported for a first application differ from the fields of information reported for a second, different application.

21. A computer program product for the automated tracking of time spent on one or more computer applications and the association of the time with accounting categories, the computer program product having a medium with a computer program embodied thereon, the computer program comprising:
computer code for registering the one or more applications and the accounting category associations;
computer code for monitoring for the use of at least one of the registered computer applications; and
computer code for recording the duration of use of at least one of the registered computer applications.

22. The computer program product of claim 21, wherein registering an application further comprises specifying a stop date for the registration.

23. The computer program product of claim 21, further comprising computer code for specifying information about the rates for billing at least one unit of time.

24. The computer program product of claim 21, wherein the user has a choice among a plurality of modes for tracking the time.

25. The computer program product of claim 24, wherein in one mode of time-tracking, the system keeps track of overall usage of an application and breaks down the usage of the application by elements of the file system, but does not assign the time to accounting categories.

26. The computer program product of claim 25, wherein in another of the plurality of modes of time-tracking, the system tracks time by elements of the file system and assigns the time to accounting categories.

27. The computer program product of claim 24, wherein in one of the plurality of modes of time-tracking, the system tracks time only while an application is in active use; and in another of the plurality of modes of time-tracking, the system tracks time as long as an application is in use, regardless of whether it is actively in use.

28. The computer program product of claim 24, wherein in one mode of time tracking, the system associates all active time during a time frame specified at registration with a specific accounting code.

29. The computer program product of claim 24, wherein in one mode of time-tracking, the system associates all active time during a time frame specified at registration with a specific accounting code, except for active time spent on specified applications.

30. The computer program product of claim 21, wherein the time is tracked for an application when a window associated with the application is in the foreground.

31. The computer program product of claim 21, further comprising the steps of:
reviewing the data recorded by the system; and
explicitly authorizing release of the data.
